(19) United States
(12) Patent Application Publication
(10) Pub. No.: US 2010/0316980 A1
(43) Pub. Date: Dec. 16, 2010

(54) Foreign Language Teaching Method And Apparatus

(76) Inventor: Pavel Pazushko, Moscow (RU)

Correspondence Address: ST. ONGE STEWARD JOHNSTON & REENS, LLC, 986 BEDFORD STREET, STAMFORD, CT, 06905-5619, US

(21) Appl. No.: 12/815,046

(22) Filed: Jun. 14, 2010

Related U.S. Application Data
(60) Provisional application No. 61/186,659, filed on Jun. 12, 2009.

(51) Int. Cl. G09B 19/06

(52) U.S. Cl. 434/157

(57) ABSTRACT

Apparatus, method and software for teaching foreign language involving a data processing system having a program executing computer, a data storage device, and an output device; one or more data files containing written information in a user's native language, the written information being of current interest to the user; computer programs executing on the data processing system for: converting lexical blocks of said written information to a desired foreign language to create a mixed language written information; and displaying the mixed language written information on the output device.

### CROSS-REFERENCE TO RELATED APPLICATIONS

The present application claims the benefit under 35 U.S.C. §119 (e) of the Provisional Patent Application Ser. No. 61/186,659, filed on Jun. 12, 2009. The contents of Provisional Patent Application Ser. No. 61/186,659, filed on Jun. 12, 2009 are hereby incorporated by reference.

### FIELD OF THE INVENTION

Method and apparatus for a foreign language learning tool based on progressive substitution of lexical blocks.

### BACKGROUND OF THE INVENTION

Learning a foreign language is often difficult and time consuming. For many people, learning a foreign language is an essential tool used to assist a person when they travel, for conducting a business, and for various other reasons.

Current foreign language tools, however, fail to satisfy the need to learn a foreign language quickly, effectively and conveniently, and to learn the language with a particular focus on a selected area of interest, such as business or technology. Current language learning tools such as the Rosetta Stone® series, as well as other programs, do not teach a highly efficient and effective way to learn a foreign language that allows a person to quickly master a foreign language, while going about a the person's life the same as before they began to learn a foreign language.

To teach the foreign language, existing foreign language learning tools utilize simple stories or static media. These tools do not utilize resources such as an internet website, business magazine, newspaper article, or other such resource that people typically use to learn about their interests. As such, existing foreign language software does not maximize the efficiency of learning a language, while allowing a person to go about their life in the same way as before they began to learn a language. In short, existing foreign language software fail to maximize a user's time and do not allow users to go about their lives the same as before they began to learn a foreign language.

Maximization of a user's time would occur if the learning tool is geared towards a particular interest or multiple interests picked by the user, such that a user will learn a foreign language, while also learning more about the particular interest picked. This makes learning a foreign language more interesting to the user, while also keeping the user up to date with their interests, and is a highly desirable way to learn a foreign language. This advantage is not available in currently existing foreign language software. Additionally, existing foreign language software does not make learning a foreign language convenient or effective, and does not allow people to go about their lives in the same way as before they began to learn the foreign language.

With existing software, many people make an attempt to learn a foreign language but give up for various reasons including: 1) users do not get desired results fast enough because learning languages is a lengthy process and the low effectiveness of current methods makes it very challenging; 2) users do not enjoy the process because current methods only use specially designed teaching materials (such as books or tapes) and employ only “canned” content of no relevance to the user; and 3) users cannot stick to a language learning routine for too long because with current methods, language learning requires undivided attention and a significant commitment of effort/time. Few people are so dedicated or have much time to spare.

Furthermore, existing foreign language software fail to teach a learning tool based on progressive substitution of lexical blocks that uses internet articles, magazines, or newspapers, and/or other such multimedia tools, that will keep a user interested in learning the foreign language, while at the same time allowing the user to learn more about the user's particular interest, be it business, technology, or any other such interest, so the user's time is maximized. One of the main challenges of learning a foreign language is the need to acquire a significant vocabulary. An average person has an active vocabulary of about 10,000 lexical units (words and phrases) in their native language. To gain some fluency in a foreign language takes at least 2,000 lexical units. This process takes a long time and consists of several steps. First, a person must memorize new words, their pronunciation and meaning. Second, a person must learn in which context to use those words. Third, a person must understand all the grammar rules related to the use of each new word (single versus plural forms for nouns, tense forms for verbs, etc). Last but not least, a person must practice use of the newly acquired lexicon in reading, speaking and listening. The existing foreign language methods are not very effective at tackling this very time consuming and difficult task of building up the new language vocabulary.

United States Patent Application No. US 2008/0059145 (Wood et al.) (the disclosure of which is hereby incorporated by reference) teaches mixing the native language and the target foreign language, and then replacing the native language with the target language based upon steps of difficulty, and doing so in the context of using multimedia devices. Although the method devised by Wood et al. employs an approach of mixing native and foreign language words, it fails to provide flexibility in terms of learner level adjustment. And most importantly, this method is based on use of didactical teaching materials (“canned content”) of no relevance to the learner, i.e. learners cannot apply the method to any content of their choice. This makes the foreign language learning process not very effective and lasting since the content is of little informational and entertainment value.

However, Wood et al. fails to teach an efficient method and device for a foreign language teaching tool based upon progressive substitution of lexical blocks that is efficient and effective for users, such as business people and executives, who require their time to be maximized.

Such a method and device is desirable in the industry and is a focus of the present application.

### SUMMARY OF THE INVENTION

The present invention involves a foreign language teaching tool involving a method, system, and apparatus and/or device that teaches a progressive substitution of lexical blocks in order to allow a user to learn a foreign language. The present invention involves allowing a user to select an interest, such that the user's time is maximized and the user learns a foreign language while keeping up with the user's interest, whether it is business, technology, or any other such interest. The present invention integrates the user's learning of a foreign language into the user's day-today activities. Users can read their favorite books, newspaper articles, Internet blogs, and other articles of interest. The present invention allows for users to read this content of choice and to learn a foreign language, whereby there is no need to dedicate additional time and effort specifically to the language learning process, which is a disadvantage of the current methods. Thus, the present invention makes learning a “by-product” of people going about their lives the same as before they began to learn the foreign language and allows for a significant goal to be achieved: the target language is introduced in a meaningful context and gradually becomes a mediator for achieving goals, not the goal itself. This is an important psychological element of the invention.

Another objective of the invention is to provide vocabulary enrichment for a user in a foreign language that is relevant to the interests of the user. Another objective of the invention is that the invention is typically tailored for the use and benefit of highly motivated language learners. Another object is to keep the sustained interest of a user through gradual input of new vocabulary.

These and other objectives are achieved by providing a method and device for learning a foreign language whereby all words in the vocabulary of a study (foreign) language are grouped into lexical categories, such as nouns, verbs, adjectives, adverbs, etc. The number of lexical categories and words in each category may vary from language to language.

This categorization principle is also applied to the grammar of the study (foreign) language to form several groups—verb forms (tense, mood, voice, aspect, etc), and other groups.

All words in the lexical categories and forms in the grammar groups are classified based on two scales—complexity (from most easy to most difficult) and frequency of use (from very rarely to most frequently used). The method and device are based upon the selective/progressive substitution of different lexical blocks (nouns [singular/plural], verbs [present/past/future/etc.], possessive terms, adjectives, adverbs, etc., whereby there is a selection of substitution of native language text with foreign language text whereby the frequency of the selection of substitution is based upon the “difficulty level.” As noted above, the “difficulty level” is based upon the complexity and frequency of use of a lexical category.

The entire language schema (lexical categories, grammar groups, and their content) is used as a basis for a translation software (FLLP, “foreign language learning program”) which is programmed to be used in a specially designed consumer electronics device (EREL, “easy read, easy learn”). EREL is used by a language learner to read any text (electronic books, newspaper articles, etc). FLLP may be either installed in the device (“a thick client”) for autonomous use by the reader, or it may be installed on a server for ASP-type Internet-based distributed access by remote devices (“thin clients”).

To use EREL for reading, the user turns on the FLLP device and selects the level of difficulty. FLLP substitutes words in the text with the corresponding words in the other language. The process may be programmed to be used two ways—replacing words in the native language with words from the foreign language, and vice versa. The selected level of difficulty determines the number and complexity of words and grammar forms to be translated by FLLP. The user can also select whether to have substituted parts of the text indicated (e.g. highlighted, underlined, different font color, etc) or not. The substituted parts of the text may be italicized, blown up in a larger font size, or furthermore distinguished visually from the rest of the text.

If experiencing difficulties with a particular sentence or the selected level of difficulty in general, the user can lower the level of difficulty one or several notches down until he/she is able to translate the phrase or gets to the desired comfort level. This flexibility allows the user to control the pace of language learning process.

FLLP can be programmed to provide additional teaching aids such as transcriptions and pronunciation of a word or entire phrase. The device can have an audio aspect whereby the sentence is read out loud to a user based upon a selected option.

The sentence may also be read as a mixture of the language and substituted text, so that a user can identify selected lexical blocks in the sentence, while keeping the rest of the sentence in the un-substituted form.

With the help of FLLP and EREL, users can learn a foreign language with minimum effort and without dedicating extra time to the learning process. Reading content of interest is an active process while language learning is a desired byproduct. The FLLP method gradually introduces foreign words and grammar structures and the learning happens very smoothly, practically on a subliminal level.

Over time, user's proficiency in the studied language builds up naturally, almost as naturally as a person's mother tongue development in the childhood. All of the above allows the new method to make the traditionally lengthy and painstaking process of learning languages much easier, faster and even fun.

The shift from texts in the native language to texts in the target language is recommended at a stage when the learner feels that his/her vocabulary is enough to read interesting texts in the target language, but at any stage it is possible to ask for more translations or to ask to return to an earlier level of complexity.

The preferred embodiment introduces the user to lexical block substitution in the context of everyday reading materials (such as news, or recreational reading such as magazines, blogs, graphical books, or books). Additional features also include transcriptions and pronunciations.

The method can be also be embodied in a software application (stand alone or web-based) accessible by computer or mobile devices such as a handheld computer, mobile telephone, smart phone, mini PC, PC, notebook, tablet PC, PDA, video game console, portable DVD player, portable Blue-Ray player, or any such electronic appliance with a screen known in the art; or in a handheld teaching device.

In another embodiment, EREL can have one or two screens. In case of a two-screen model, the main screen is used for reading text while the secondary one is for reference purposes.

The main screen of EREL has several functions and serves the following purposes: (1) displays text for user's viewing and reading (the screen can be black-n-white or color); (2) indicates which parts of the text are substituted with words from the studied foreign language (these words can be highlighted, underlined, different font color/size/type, etc); and (3) allows the user to look up translation or pronunciation of a word or phrase by touching it on the screen (it's a touch screen display).

The secondary screen of a two-screen EREL is used for reference purposes. Thus the user can see which new words are used in the text on the main screen. The featured words are displayed with their definition, transcription, and usage examples.

If equipped with a speech recognition block, EREL can also allow the user to check the correctness of his/her pronunciation of the studied foreign language words and phrases. Thus, EREL analyzes the word(s) spoken by the user and provides immediate feedback by evaluating the pronunciation using a scoring system.

In another embodiment, the FLLP may have audio and Braille capabilities to allow the device to be used by the blind.

In another embodiment, the FLLP may have video, and/or touch screen capabilities to allow the device to be used by the deaf.

In another embodiment, the FLLP may be programmed to receive daily updates from a central server, which selects news articles or internet blogs according to the interest selected by the user. The device allows for the daily updates to be translated into lexical blocks, based upon the “difficulty level,” so that the foreign language may be taught while keeping up with the user's interests. The FLLP is interactive and may receive updates with the server. The FLLP may also upload information to the server to allow for analysis of the user's proficiency level. This way, the data may be analyzed and may evaluate the progress of the user.

In another embodiment, the FLLP may receive information from a news or television station. The FLLP may translate the incoming data stream into the study (foreign) language and may stream a mixture of the native and target language for the benefit of the user based upon the “difficulty level” selected.

In another embodiment, the EREL may involve multiple languages such that a sentence may be expressed in more than two languages.

In another embodiment, the FLLP may receive information and translate the text into visual images and pictorial images, such that a user may select a word and a corresponding picture is presented, so that the user may related the corresponding word to a visual image.

In another embodiment, the FLLP may receive both visual (printed word+transcription) and audio presentation. This corrects a usual problem of learning through reading in languages with complex sound-letter correspondence (like in English or French). This further may make the program useful for students with different learning styles, as it will work for both visualizers and students with preference for audio input.

In another embodiment, the FLLP may be linked to a particular news or online magazine, such that daily updates are downloaded from the online magazine.

In another embodiment, the FLLP contains a quiz system to quiz a user both on the contents of the online magazine and the foreign language. This way a user can access his/her knowledge on both their interest and the foreign language desired to be learned.

In another embodiment, the FLLP contains a thesaurus such that multiple words can be progressively substituted into the text. Based upon the difficulty level, other words may be dynamically selected which contain the same meaning. Furthermore, the user may select a word and synonyms and antonyms are presented in order to expand the vocabulary of the user.

In another embodiment, the FLLP contains a reference database which stores the user's proficiency data and offers suggestions to the “difficulty level” the user should select. The database uses data such as the user's age, past proficiency data accumulated by the FLLP, frequency of use of the program, and other factors to select the appropriate “difficulty level” for the user.

In another embodiment, the FLLP is able to stream information from multiple servers such that the most current information based upon the user's selected interest is used and progressively substituted against.

In another embodiment, the FLLP contains a search engine to allow the user to select multiple news articles and various internet resources to be translated and progressively substituted against. This allows the user to dynamically pick reading materials, which the user finds interesting, and allows the user to learn the foreign language through these news articles.

In another embodiment, the FLLP can pull emails from a network server such that the emails are translated and a user can learn a foreign language through normal reading of the user's emails. This may allow the FLLP method to be placed within a normal email program such as Microsoft Outlook®.

In another embodiment, the FLLP method to be placed within various company and proprietary software such as Microsoft PowerPoint®, Microsoft Word® and other such programs, so that progressive substitution and be done for oral presentations, allowing multiple users to learn the foreign language selected.

The disclosures of the following documents are hereby incorporated by reference:
US Patent Pub. No. 2008/0059145 Wood et al.;
US Patent Pub. No. 2006/0019223 A1 Wood et al.;
US Patent Pub. No. 2008/0109207 A1 Wood et al.;
US Patent Pub. No. 2007/0269775 A1 Andreev et al.;
US Patent Pub. No. 2005/0053900 A1 Kaufmann et al.;
US Patent Pub. No. 2002/0058234 A1 West et al.;
U.S. Pat. No. 6,024,571 Renegar;
U.S. Pat. No. 6,341,958 Zilberman;
U.S. Pat. No. 5,697,789 Sameth et al.; and
U.S. Pat. No. 5,275,569 Watkins.

Additionally, the present invention provides for an apparatus for teaching foreign language, comprising: a data processing system having a program executing computer, a data storage device, and an output device; one or more data files containing written information in a user's native language, the written information being of current interest to the user; one or more data files containing written information in a user's foreign language, the written information being of current interest to the user; computer programs executing on the data processing system for: converting lexical blocks of the written information in a user's native language to written information in a user's foreign language and vice-versa to create a mixed language written information; and displaying the mixed language written information on the output device.

The data processing system of the apparatus may be a handheld computer, PDA, mobile phone or other handheld device.

The program executing computer may be a non-mobile computer. The output device may be a screen display associated with the non-mobile computer. The output device may be a handheld device receiving the mixed language written information by wireless communication from the non-mobile computer.

The one or more data files may be comprised of news articles, recreational reading materials, business reading materials, or emails directed to the user. Additionally, the data files may contain mixed language written information.

The present invention provides for a method of teaching foreign language comprising: receiving one or more data files containing written information of current interest to the user in a user's native language at a data processing system having a program executing computer, a data storage device, and an output device; receiving one or more data files containing written information of current interest to the user in a user's foreign language; storing the one or more data files in the data storage device; executing computer programs on the data processing system for: converting lexical blocks of the written information in a user's native language to written information in a user's foreign language and vice-versa to create a mixed language written information; and displaying the mixed language written information on the output device.

The data processing system may be a handheld computer, PDA, mobile phone or other handheld device. The program executing computer may be a non-mobile computer.

The output device may be a screen display associated with the non-mobile computer. The output device may be a handheld device receiving the mixed language written information by wireless communication from the non-mobile computer.

The one or more data files may be comprised of news articles, recreational reading materials, business reading materials, or emails directed to the user. The data files may contain the mixed language written information.

The present invention also provides for a software for teaching foreign language, comprising: computer programs stored on a data storage device for receiving one or more data files containing written information of current interest to the user in a user's native language; converting lexical blocks of the written information in a user's native language to written information in a user's foreign language and vice-versa to create a mixed language written information; and displaying the mixed language written information on the output device.

The data storage device may be a handheld computer, PDA, mobile phone or other handheld device. The data storage device may be a non-mobile computer.

The one or more data files may comprise news articles, recreational reading materials, business reading materials, or emails directed to the user.

The one or more data files may contain the mixed language written information.

Additionally, the invention is not limited to these embodiments, as other combinations to produce a laminated product are contemplated by the invention. Other objects of the invention and its particular features and advantages will become more apparent from consideration of the following drawings and accompanying detailed description. It should be understood that the detailed description and specific examples, while indicating the preferred embodiment of the invention, are intended for purposes of illustration only and are not intended to limit the scope of the invention.

### BRIEF DESCRIPTION OF DRAWINGS

FIG. 1 is a schematic illustration of the apparatus and method of the invention; and

FIG. 2 is a flowchart of an illustrative embodiment of the invention showing a word usage frequency analysis within NL and FL lexicon groups.

### DETAILED DESCRIPTION OF THE INVENTION

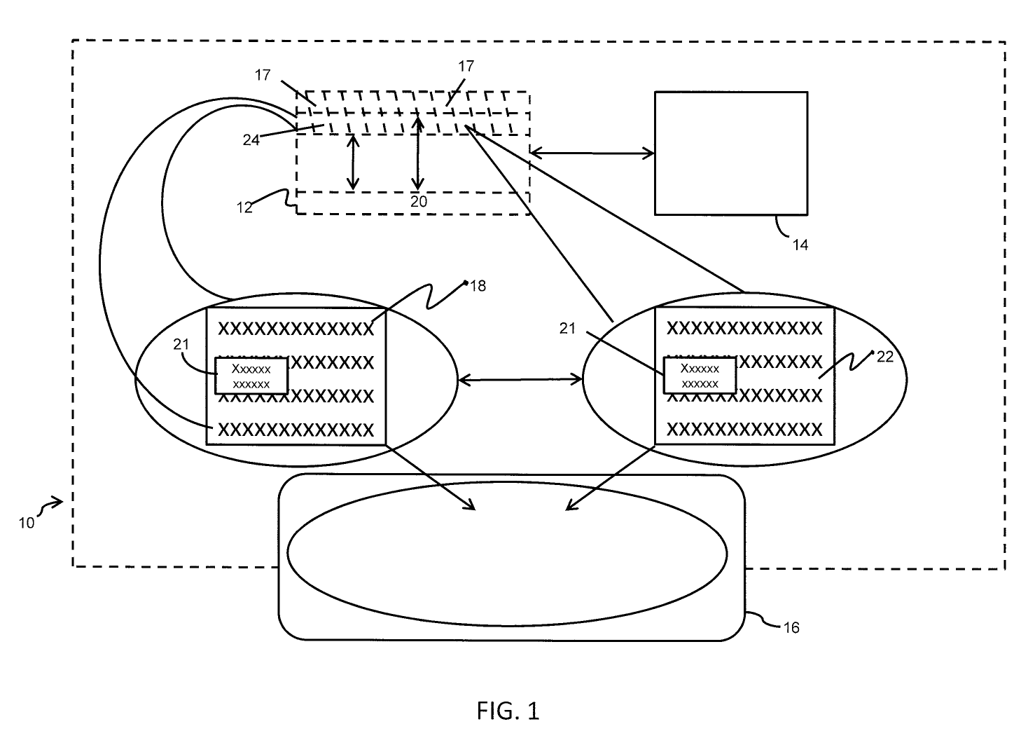

Referring now to FIG. 1, an illustrative embodiment of the invention is shown. In the embodiment of the invention shown in FIG. 1, a data processing system 10 having a program executing computer 12, a data storage device 14, and an output device 16; is provided with one or more data files 17 containing written information 18 in a user's native language, the written information being of current interest to the user. Computer programs 20 executing on the computer 12 convert lexical blocks 21 of the written information to a desired foreign language to create a mixed language written information 22. The mixed language written information 22 is then displayed on the output device 16 and may be stored in a separate data file 24.

In an alternative embodiment, the one or more data files contain written information in a user's foreign language (the language desired to be learned), and the computer programs convert lexical blocks of the written information to the user's native foreign language to create a mixed language written information based on a foreign language document instead of a native language document.

In preferred embodiments, the system is adapted for use in a mobile computing environment, either directly, where the data processing system is a handheld computer, PDA, mobile phone or other handheld device; or indirectly, where the program executing computer is a non-mobile computer but the output device is a handheld device such as a mobile phone receiving the mixed language written information by wireless communication from the non-mobile computer.

As noted above, the apparatus, method and software for foreign language learning in accordance with the invention are based on progressive substitution of lexical blocks. The method and device allow for progressive substitution of lexical blocks based upon a user selected “difficulty level.” The method and device categorize vocabulary of a foreign language and grammar of a foreign language into lexical blocks based on complexity and frequency of use, which forms the “difficulty level.” The lexical blocks are then progressively substituted into text, whereby a user's preselected interest is used to form the basis of the original text to be substituted.

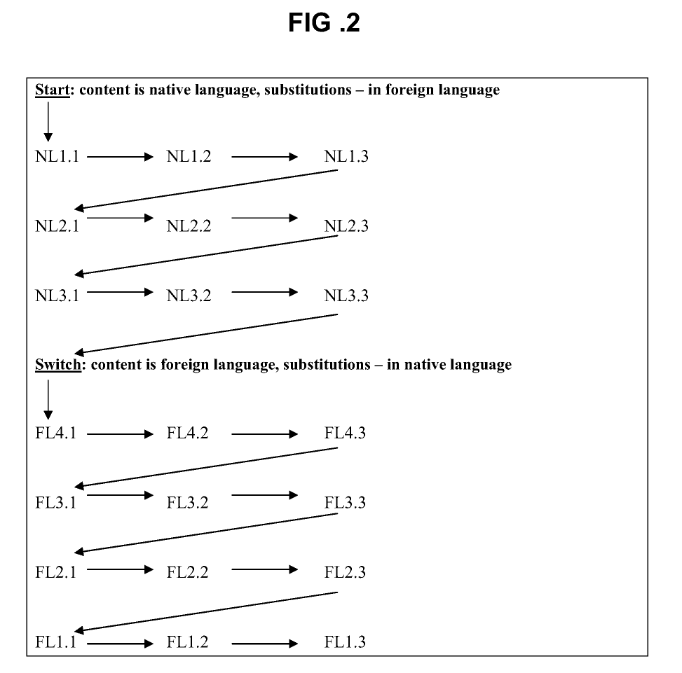

Referring now to FIG. 2, a flowchart of an illustrative embodiment of the invention is shown. The first phase of the process includes lexicon analysis and comparison between the Native Language (NL) and Foreign Language (FL). Next, lexicons of NL and FL are split into special groupings using the following schema:

NL1 Group: words and expressions in NL with exactly the same meaning as their equivalents in FL (i.e. have a direct non-dubious translation). NL2 Group: words and expressions in NL which have a very close meaning as their equivalents in FL. NL3 Group: words and expressions in NL which have the same or very close meaning as their equivalents in FL at least 95% of the time. NL4 Group: the remaining words and expressions in NL.

FL1 Group: words and expressions in FL with exactly the same meaning as their equivalents in NL (i.e. have a direct non-dubious translation). FL2 Group: words and expressions in FL which have a very close meaning as their equivalents in NL. FL3 Group: words and expressions in FL which have the same or very close meaning as their equivalents in NL at least 95% of the time. FL4 Group: the remaining words and expressions in FL.

The second phase of the process includes a word usage frequency analysis within NL and FL lexicon groups. Based on analysis results, subgroups (lexical blocks) are formed in the order frequency usage level.

Tables 1 and 2 below are sample subgroup (lexical block) matrices based on NL and FL respectively. Based on the nature of a language the number of subgroups (lexical blocks) can vary.

TABLE 1

| Usage | NL1 | NL2 | NL3 | NL4 |
|---|---|---|---|---|
| Frequency | subgroups | subgroups | subgroups | subgroups |
| Highest | NL1.1 | NL2.1 | NL3.1 | NL4.1 |
| High | NL1.2 | NL2.2 | NL3.2 | NL4.2 |
| Medium | NL1.3 | NL2.3 | NL3.3 | NL4.3 |
| Low | NL1.4 | NL2.4 | NL3.4 | NL4.4 |
| Lowest | NL1.5 | NL2.5 | NL3.5 | NL4.5 |

TABLE 2

| Usage | FL1 | FL2 | FL3 | FL4 |
|---|---|---|---|---|
| Frequency | subgroups | subgroups | subgroups | subgroups |
| Highest | FL1.1 | FL2.1 | FL3.1 | FL4.1 |
| High | FL1.2 | FL2.2 | FL3.2 | FL4.2 |
| Medium | FL1.3 | FL2.3 | FL3.3 | FL4.3 |
| Low | FL1.4 | FL2.4 | FL3.4 | FL4.4 |
| Lowest | FL1.5 | FL2.5 | FL3.5 | FL4.5 |

The invention may be used for practical purposes of learning foreign languages with the help of specially designed software (FLLP). FLLP is deployed within any electronic communication device such as mobile phone, e-book, computer, etc. FLLP can be applied to any text on those electronic devices whether it's content on local hard drive or streaming via the Internet or other info network.

Once a user turns on the FLLP on the device, he/she may be presented with content in NL with selected word substitutions in FL. The progression goes from group NL1 to NL2, then NL3 (group NL4 is not actively studied). Within each group the flow is from the highest frequency to medium frequency subgroups. Once the last subgroup of group NL3 is reached, FLLP makes a switch by presenting content in FL and making selective substitutions with NL words. The same progression now goes from group FL1 to FL2, then FL3, and finally FL4.

Once FLLP makes the switch to content in FL and begins the progression from FL1.1 to FL4.3, any FL words learned in the NL1.1-NL3.1 levels do not get substituted anymore. The assumption is that by now the user has learned those words and would recognize them in FL text.

When encountering low-frequency words in FL, the user can always use FLLP to look up their dictionary translation in NL.

Grammar is learned along the way with the help of corresponding markings provided by FLLP and User's linguistic guess. This process may mostly occur during the NL1.1-NL3.1 levels.

In automatic mode, FLLP gradually increases the difficulty level as shown by arrows in FIG. 2. However, at any point the user may manually change the level up or down the scale which provides maximum flexibility and a stress free learning environment. Also, the user may point at any FL word and get a pop-up with its phonetic transcription as well as audio pronunciation.

While the invention has been specifically described in connection with certain specific embodiments thereof, it is to be understood that this is by way of illustration and not of limitation and that various changes and modifications in form and details may be made thereto, and the scope of the appended claims should be construed as broadly as the prior art will permit.

The description of the invention is merely exemplary in nature, and thus, variations that do not depart from the gist of the invention are intended to be within the scope of the invention. Such variations are not to be regarded as a departure from the spirit and scope of the invention.

What is claimed is:

1. An apparatus for teaching foreign language, comprising:
a data processing system having a program executing computer, a data storage device, and an output device;
one or more data files, said data files containing written information in a user's native language, said written information being of current interest to the user, and/or said data files containing written information in a user's foreign language, said written information being of current interest to the user; and
computer programs executing on said data processing system for:
converting lexical blocks of said written information in a user's native language to written information in a user's foreign language and/or converting lexical blocks of said written information in a user's foreign language to written information in a user's native language, to create a mixed language written information; and
displaying the mixed language written information on the output device.

2. The apparatus of claim 1, wherein the data processing system is a handheld computer, PDA, mobile phone or other handheld device.

3. The apparatus of claim 1, wherein the program executing computer is a non-mobile computer.

4. The apparatus of claim 3, wherein the output device is a screen display associated with the non-mobile computer.

5. The apparatus of claim 3, wherein the output device is a handheld device receiving the mixed language written information by wireless communication from the non-mobile computer.

6. The apparatus of claim 1, wherein the one or more data files comprise news articles, recreational reading materials, business reading materials, or emails directed to the user.

7. The apparatus of claim 1, further comprising data files containing the mixed language written information.

8. A method of teaching foreign language comprising:
receiving one or more data files, said data files containing written information in a user's native language, said written information being of current interest to the user, and/or said data files containing written information in a user's foreign language, said written information being of current interest to the user, at a data processing system having a program executing computer, a data storage device, and an output device;
receiving one or more data files containing written information of current interest to the user in a user's foreign language;
storing the one or more data files in the data storage device;
executing computer programs on said data processing system for:
converting lexical blocks of said written information in a user's native language to written information in a user's foreign language and/or converting lexical blocks of said written information in a user's foreign language to written information in a user's native language, to create a mixed language written information; and
displaying the mixed language written information on the output device.

9. The method of claim 8, wherein the data processing system is a handheld computer, PDA, mobile phone or other handheld device.

10. The method of claim 8, wherein the program executing computer is a non-mobile computer.

11. The method of claim 10, wherein the output device is a screen display associated with the non-mobile computer.

12. The method of claim 10, wherein the output device is a handheld device receiving the mixed language written information by wireless communication from the non-mobile computer.

13. The method of claim 8, wherein the one or more data files comprise news articles, recreational reading materials, business reading materials, or emails directed to the user.

14. The method of claim 8, further comprising data files containing the mixed language written information.

15. A software for teaching foreign language, comprising:
computer programs stored on a data storage device for:
receiving one or more data files, said data files containing written information in a user's native language, said written information being of current interest to the user, and/or said data files containing written information in a user's foreign language, said written information being of current interest to the user;
converting lexical blocks of said written information in a user's native language to written information in a user's foreign language and/or converting lexical blocks of said written information in a user's foreign language to written information in a user's native language, to create a mixed language written information; and
displaying the mixed language written information.

16. The software of claim 15, wherein the data storage device is a handheld computer, PDA, mobile phone or other handheld device.

17. The software of claim 15, wherein the data storage device is a non-mobile computer.

18. The software of claim 15, wherein the one or more data files comprise news articles, recreational reading materials, business reading materials, or emails directed to the user.

19. The software of claim 15, further comprising data files containing the mixed language written information.
